(19) United States
(12) Patent Application Publication
(10) Pub. No.: US 2012/0158451 A1
(43) Pub. Date: Jun. 21, 2012

(54) Dispatching Tasks in a Business Process Management System

(75) Inventor: Georges-Henri Moll, Valbonne (FR)

(73) Assignee: INTERNATIONAL BUSINESS MACHINES CORPORATION, Armonk, NY (US)

(21) Appl. No.: 13/327,917

(22) Filed: Dec. 16, 2011

(30) Foreign Application Priority Data
Dec. 16, 2010 (EP) 10306433.3

(51) Int. Cl. G06Q 10/06

(52) U.S. Cl. 705/7.25

(57) ABSTRACT

A system and method for dispatching tasks in a business process management system are provided, whereby tasks are automatically dispatched to a queue for being processed by at least one out of multiple resources. The method includes generating a forecast of further tasks to be dispatched in the future and dispatching each task to the queue for being processed by at least one resource under consideration of the forecast of further tasks to be dispatched in the future.

### BACKGROUND

Embodiment of the present invention relate to a method and a system for dispatching tasks in a business process management system, whereby tasks are each automatically dispatched to a queue for being processed by at least one out of multiple resources. The invention further relates to a computer-readable medium containing a set of instructions that causes a computer to perform the above method and a computer program product for executing the above method.

Business process management (BPM) involves managing the workflow of information and documents inside a company or across different companies. BPM tasks, sometimes also referred to as steps, are most often performed by human or machine resources including, for example, computers. BPM workflow is often depicted as a graph including nodes and arcs, whereby the nodes are most frequently used to represent the tasks or steps to be performed. The arcs are most frequently paths from one node to another, depicting possible process flows.

In a BPM process, for example, a given document or event may be routed differently through human or machine processing depending on the outcome of a processing at each step it encounters. In certain instances, the outcome of the step determines the next step in the processing. With other steps, the process will always proceed to a particular following step, regardless of the outcome of the step.

Current BPM process management systems assign a given task to a given resource in a control-oriented manner. Incoming tasks can be queued to task queues, also referred to as step queues, to be assigned to a suitable resource upon availability. This is referred to as pushing. Incoming tasks can also be queued to resource queues to the different resources, which is sometimes referred to as pushing. Also the simultaneous use of task queues and resource queues can be implemented.

In control-oriented processing, documents are often queued into task queues. The BPM management system then redirects these tasks to resource queues depending on the state of one or more step queues at a given moment. Also solutions considering the status of all queues at a given moment are known in the art. The allocation can be realized automatically or even by a user, who is responsible for dispatching the tasks from the step queue to at least one of the resource queues.

According to the US patent application No. 2009/0228309 A1, it is further known to consider an estimation of arising tasks based on currently dispatched tasks. This already improves the performance of a task dispatcher inside the BPM management system. Nevertheless, such a system has limitations, since it is not aware of tasks that have not yet been queued into one of the queues.

### BRIEF SUMMARY

Embodiments of the invention may therefore provide a method and system for dispatching tasks in a business process management system, which perform an automatic dispatching of the tasks to the resource and which improves the performance of a business process management system. Embodiments of the present invention may also provide a computer-readable medium and a computer program product for performing the above method and to be used in the above system.

Accordingly, a method is provided for dispatching tasks in a business process management system, whereby tasks are automatically dispatched to a queue for being processed by at least one out of multiple resources, the method comprising the steps of: generating a forecast of further tasks to be dispatched in the future, dispatching each task to the queue for being processed by at least one resource under consideration of the forecast of further tasks to be dispatched in the future.

A system is provided for dispatching tasks in a business process management system comprising a storage device for storing computer usable program code and a processor for executing the computer usable program code to perform the above method.

A computer-readable media is also provided, such as a storage device, a floppy disk, compact disc, CD, digital versatile disc, DVD, Blu-ray disc, or a random access memory, RAM, containing a set of instructions that causes a computer to perform the above method and a computer program product comprising a computer-usable medium including a computer-usable program code, wherein the computer-usable program code is adapted to execute the above method.

A basic idea of embodiments of the invention is to improve the dispatching of the tasks by additional consideration of the forecasts of further tasks to be dispatched in the future. This allows implementing a dispatching of the tasks depending on tasks, which have not yet entered the BPM system, which also refers to tasks belonging to processes which have not yet been started. Accordingly, tasks will be dispatched to the queues even though they might at the current time not be best choice, preventing the corresponding resources being blocked for future tasks. Therefore, the overall performance of the BPM system can be improved. The forecast is independent from the type of used queues, i.e. task queues and/or resource queues. The dispatching can be implemented in different ways, for example based internal rules.

In a modified embodiment of the present invention the step of automatically dispatching each task to a queue for being processed by the at least one resource under consideration of the forecast of further tasks to be dispatched in the future comprises performing an optimized planning of an allocation of the resources. The optimized planning refers to an evaluation of dependencies between different tasks, so that individual tasks can be scheduled in a most suitable way. In one business project, one task can depend on the result of another task, so that this other task has to be scheduled to be executed first and even to terminate before the first task is started. Accordingly, the first task will not block the respective resource and the overall performance of the BPM system is improved. The additional consideration of future tasks allows for a further improvement of the system performance. Such an optimized planning of an allocation of the resource queues can for example be implemented using a Mixed Integer Programming model (MIP). This model allows knowing the optimal resource allocation for a given time horizon under consideration of the time each resource should spent working on each task for each time bucket and what quantity of processed item this represents. Details regarding optimized planning have been described in the US 2009/0228309 A1 of the same inventor, which is herewith included by reference.

According to a modified embodiment of the present invention the step of performing an optimized planning of an allocation of the resources comprises prioritizing resources and/or tasks. Prioritizing resources, which refers to pulling, refers to assigning a priority for assigning a task to a resource, when multiple resources are suitable for performing the task. Prioritizing tasks, which refers to pushing, refers to assigning a priority to the task, and assigning it to one of the resources according to its priority, when multiple resources are available for performing this task. Also a combined use of prioritizing resources and tasks can be implemented.

In a preferred embodiment of the present invention the step of generating a forecast of further tasks to be dispatched in the future comprises using an Auto Regression Integrated Moving Average, ARIMA, for providing the forecast. Auto Regression Integrated Moving Average (ARIMA) is the state of the art in the domain of endogenous forecasting, which refers to non explicative forecasting. ARIMA forecasting is known in the art and is therefore not described in detail in this document.

In a modified embodiment of the present invention the step of generating a forecast of further tasks to be dispatched in the future comprises evaluating historical task data. The historical task data can be logged within the business process management system and provides a basis for evaluating the occurrence of future tasks.

A modified embodiment of the present invention comprises the steps of monitoring a current state of the queues, comparing the current state of the queues to the forecast, and, in case of a mismatch between the forecast and the current state of the queues, providing an actualized forecast and dispatching each task on basis of the actualized forecast. Since the forecast can quickly diverge from reality, updating of the forecast is required to allow always most efficient dispatching of the tasks to one of the queues. This step can further comprise a re-allocation of tasks, i.e. dispatching tasks, which have already been assigned to one of the queues, again, so that the current dispatching will be improved under consideration of the updated forecast.

In a further improved embodiment of the present invention the step of comparing the current state of the queues to the forecast comprises calculating reality-to-forecast divergence metric. The divergence metric can be applied to each queue individually, e.g. by assigning individual threshold values for each queue. Also a globally assigned threshold value can be used, which is based on an average value. The metric can be based on the size the queues in respect of a number of tasks or in respect of an estimated processing time of the queued tasks.

According to a modified embodiment of the present invention, the step of calculating reality-to-forecast divergence metric comprises subtracting a size of a real queue from a size of the forecast of the respective queue, forming the absolute value of the subtraction result, and dividing the result by the size of the real queue. This is a suitable metric but simple metric, which can easily be applied to the queues.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

According to an embodiment of the present invention, there is provided a method comprising generating a forecast of at least one task in a business process management system to be dispatched in the future, and dispatching the at least one task automatically to a first queue to be processed by at least one resource under consideration of the forecast of the at least one task in the business process management system to be dispatched in the future.

According to an embodiment of the present invention, there is provided a computer readable storage medium comprising a set of instructions, which, if executed by a processor, cause a computer to generate a forecast of at least one task in a business process management system to be dispatched in the future, and dispatch the at least one task automatically to a first queue to be processed by at least one resource under consideration of the forecast of the at least one task in the business process management system to be dispatched in the future.

According to an embodiment of the present invention, there is provided a system comprising a processor, and a computer readable storage medium including a set of instructions, which, if executed by a processor, cause a computer to generate a forecast of at least one task in a business process management system to be dispatched in the future, and dispatch the at least one task automatically to a first queue to be processed by at least one resource under consideration of the forecast of the at least one task in the business process management system to be dispatched in the future.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a schematic diagram of a business process management system in accordance with an embodiment of the present invention;

FIG. 2 illustrates a coordination module of the business process management system in accordance with an embodiment of the present invention; and

FIG. 3 is a schematic diagram of a flowchart of the method for dispatching tasks to the different resource queues in accordance with an embodiment of the present invention.

### DETAILED DESCRIPTION

A method and system for dispatching tasks in a business process management system according to embodiments of the present invention will be described below with reference to the accompanying drawings.

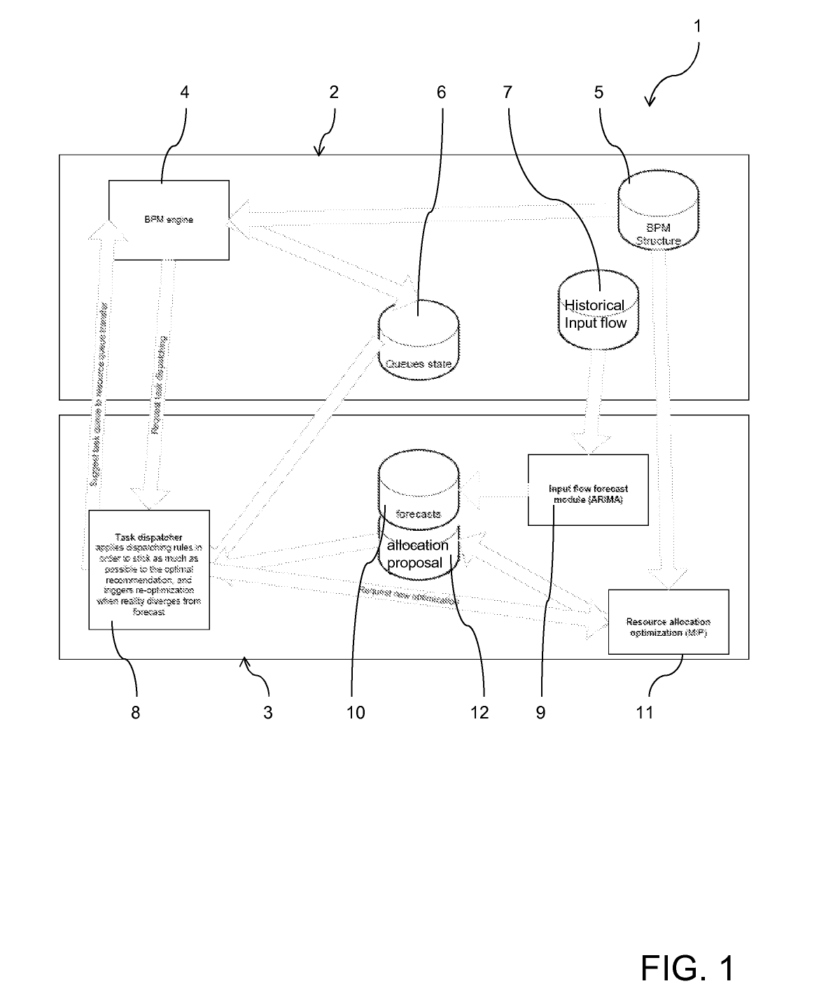

Referring now to FIG. 1, a business process management system 1 (BPM system) can be seen. The BPM system 1 includes in this embodiment of the present invention a BPM process server layer 2 and a BPM execution optimization layer 3, which is also referred to as coordination module. The BPM process layer 2 includes a BPM engine 4, which is based on a given BPM structure 5. According to the BPM structure 5, the BPM process server layer 2 further includes a number of queues 6 for receiving tasks and providing them to different resources. The queues in this embodiment are implemented as a combination of a task queue for incoming tasks and resource queues, which are not explicitly distinguished. Within the BPM process server layer 2, a storage 7 for a historical input flow of tasks is provided, which logs all input flows to the BPM system 1.

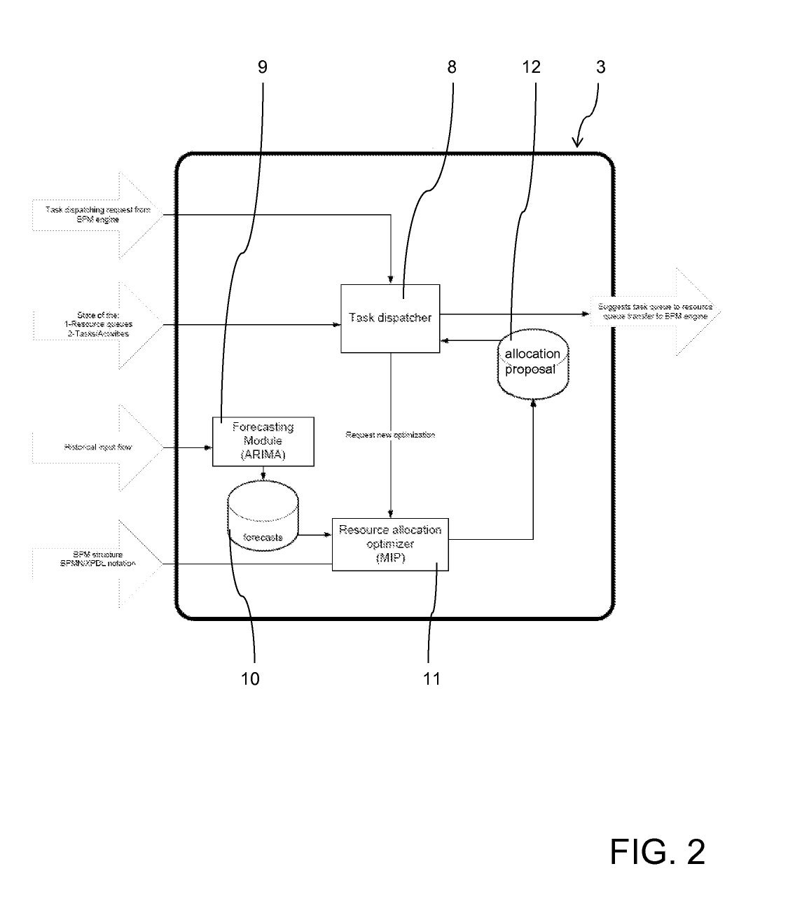

The control module 3, which can be seen in more detail in FIG. 2, includes a task dispatcher 8, which receives requests for task dispatching from the BPM engine 4 and provides suggestions for transferring tasks between the queues, i.e. from the task queue to a resource queue. The task dispatcher 8 is further connected to the queues 6 and receives a state of the queues 6 as input information. The control module 3 further includes an input flow forecast module 9, which receives the historical input flow from the storage 7. The input flow forecast module 9 implements an Auto Regression Integrated Moving Average Algorithm (ARIMA-algorithm), and is therefore also referred to as ARIMA-module. The ARIMA-module 9 provides a forecast 10 of the input flow of further tasks to be dispatched in the BPM system 1 in the future.

The control module 3 further includes a resource allocation optimization module 11, which requires as input the BPM structure 5 of the BPM system 1. The resource allocation optimization module 11 receives a trigger input from the task dispatcher 8 for performing a resource allocation optimization. The resource allocation optimization module 11 implements a mixed integer programming model (MIP model) for calculating an optimal resource allocation of the tasks. Under consideration of the forecast 10 the MIP module 11 calculates an allocation proposal 12, which is provided to the task dispatcher 8.

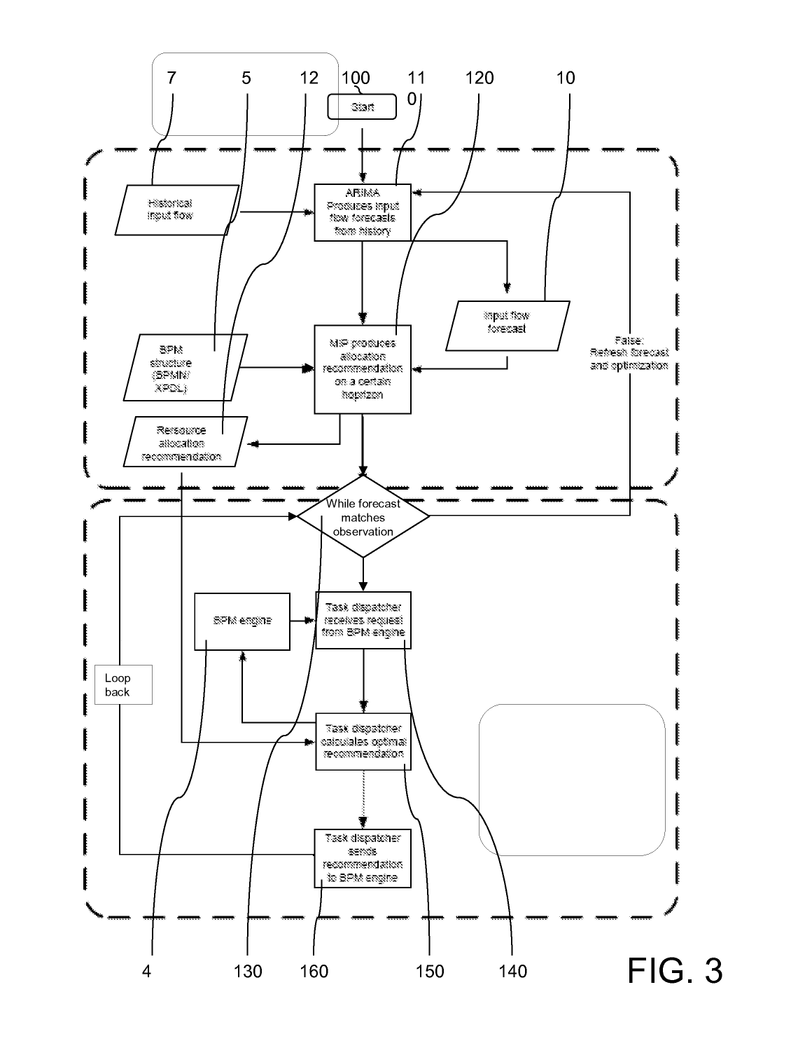

Referring now to FIG. 3, a flow diagram of an implementation of the coordination module 3 is given. According to the flowchart, the method starts in step 100.

In step 110, the ARIMA module 9 calculates an input flow forecast 10 based on the storage 7 providing the historical input flow from the BPM process server layer 2.

According to step 120, the MIP module 11 receives the BPM structure 5 and the input flow forecast 10. The MIP module 10, here also denoted resource allocation optimizer, then calculates an optimized resource allocation 12 for all currently available tasks under consideration of the current state of the queues 6 and the input flow forecast 10 of the ARIMA module 9.

In step 130, the task dispatcher 8 is in a waiting state and continuously verifies, if the forecast matches the observation of the current flow. Accordingly, a metric is applied, which subtracts the size of the real queue 6 of from the size of the forecast 10 of the respective queue 6 and takes the absolute value of the result of this subtraction to be divided by the size of the real queue 6. If a threshold value is exceeded, the input flow forecast 10 does no longer match sufficiently the real input flow of tasks to the BPM engine 4 and then returns to step 110 to refresh the forecast 10 and the optimized resource allocation 12.

Upon reception of a request to dispatch a task from the BPM engine 4, the method continues to step 140. The request to dispatch a task is received by the task dispatcher 8.

According to step 150, the task dispatcher 8 calculates under consideration of the resource allocation recommendation 12 from the MIP module 11 an optimal recommendation for dispatching the task to a queue 6. The optimal recommendation is formed for the task dispatching by prioritizing resources, when pulling is implemented, or by prioritizing steps, when pushing is implemented. In the present embodiment, both are implemented, and a combined prioritization of resources and steps is performed. The optimal recommendation provides the reality to forecast divergence metric with the maximum value.

According to step 160, the task dispatcher 8 sends a recommendation for assigning the task to a queue 6 to the BPM engine 4. The BPM engine 4 then assigns the task according to the recommendation to the queue 6. The method then returns to step 130.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been illustrated and described in detail in the drawings and fore-going description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “including” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

It is to be recognized that the embodiments described above are only illustrative, not limitative. For example, as mentioned above, for a command which is not to be executed in real time, it is checked whether an execution result thereof has existed, and if the execution result thereof has existed, the execution result is sent directly to the management platform without executing the command once more. This can decrease the number of executed commands and reduce the workload of the cloud environment. However, in order to reduce the workload of the command analyzer 401, this checking may be not performed, and instead, all commands which are not to be executed in real time are subjected to the packaging processing, and then are sent to the remote machine 601 for execution.

Although the exemplary embodiments of the present invention have been shown and described, it is to be understood by those skilled in the art that various changes in form and details can be made thereto without departing from the scope and spirit of the present invention as defined in the following claims and equivalents thereof.

We claim:

1. A method, comprising:
generating a forecast of at least one task in a business process management system to be dispatched in the future; and
dispatching the at least one task automatically to a first queue to be processed by at least one resource under consideration of the forecast of the at least one task in the business process management system to be dispatched in the future.

2. The method according to claim 1, wherein the step of dispatching the at least one task to a first queue includes performing an optimized planning of an allocation of the resources.

3. The method according to claim 2, wherein the performing the optimized planning of an allocation of the resources includes prioritizing one or more or resources and tasks.

4. The method according to claim 1, wherein the step of generating a forecast of at least one task in the business process management system to be dispatched in the future includes using an Auto Regression Integrated Moving Average (ARIMA) for providing the forecast.

5. The method according to claim 1, wherein the step of generating a forecast of at least one task in the business process management system to be dispatched in the future includes evaluating historical task data.

6. The method according to claim 1, further including,
monitoring a current state of the first queue and a second queue;
comparing the current state of the first queue and a second queue to the forecast;
providing an actualized forecast if there is a mismatch between the forecast and the current state of the first queue and a second queue; and
dispatching each task on basis of the actualized forecast.

7. The method according to claim 6, wherein the step of comparing the current state of the first queue and the second queue to the forecast includes calculating reality-to-forecast divergence metric.

8. The method according to claim 7, wherein the calculating reality-to-forecast divergence metric includes,
subtracting a size of a real queue from a size of the forecast of a respective queue to determine a subtraction result;
determining an absolute value of the subtraction result; and
dividing the result by the size of the real queue.

9. A computer program product comprising:
a computer readable storage medium; and
computer usable code stored on the computer readable storage medium, where, if executed by a processor, the computer usable code causes a computer to:
generate a forecast of at least one task in a business process management system to be dispatched in the future; and
dispatch the at least one task automatically to a first queue to be processed by at least one resource under consideration of the forecast of the at least one task in the business process management system to be dispatched in the future.

10. The computer program product according to claim 9, wherein the dispatch of the at least one task to a first queue includes performing an optimized planning of an allocation of the resources.

11. The computer program product according to claim 10, wherein the optimized planning of an allocation of the resources includes prioritizing one or more of resources and tasks.

12. The computer program product according to claim 9, generating the forecast of at least one task in the business process management system to be dispatched in the future includes using an Auto Regression Integrated Moving Average (ARIMA) for providing the forecast.

13. The computer program product according to claim 9, wherein generating the forecast of at least one task in the business process management system to be dispatched in the future includes evaluating historical task data.

14. The computer program product according to claim 9, the computer usable code is further configured to:
monitor a current state of the first queue and a second queue;
compare the current state of the first queue and a second queue to the forecast;
providing an actualized forecast if there is a mismatch between the forecast and the current state of the first queue and a second queue; and
dispatch each task on basis of the actualized forecast.

15. The computer program product according to claim 14, wherein comparing the current state of the first queue and the second queue to the forecast includes calculating reality-to-forecast divergence metric.

16. The computer program product according to claim 15, wherein calculating reality-to-forecast divergence metric includes,
subtracting a size of a real queue from a size of the forecast of a respective queue to determine a subtraction result;
determining an absolute value of the subtraction result; and
dividing the result by the size of the real queue.

17. A system comprising:
a processor; and
a computer readable storage medium; and
computer usable code stored on the computer readable storage medium, where, if executed by a processor, the computer usable code causes a computer to:
generate a forecast of at least one task in a business process management system to be dispatched in the future; and
dispatch the at least one task automatically to a first queue to be processed by at least one resource under consideration of the forecast of the at least one task in the business process management system to be dispatched in the future.

18. The system according to claim 17, wherein the dispatch of the at least one task to a first queue includes performing an optimized planning of an allocation of the resources.

19. The system according to claim 18, wherein performing the optimized planning of an allocation of the resources includes prioritizing one or more or resources and tasks.

20. The system according to claim 17, wherein generating the forecast of at least one task in the business process management system to be dispatched in the future includes using an Auto Regression Integrated Moving Average (ARIMA) for providing the forecast.
